(19) United States
(12) Patent Application Publication
(10) Pub. No.: US 2020/0188928 A1
(43) Pub. Date: Jun. 18, 2020

(54) MAGNETIC PARTICLE MANIPULATING CONTAINER AND MAGNETIC PARTICLE MANIPULATING APPARATUS

(71) Applicant: SHIMADZU CORPORATION, Kyoto-shi (JP)

(72) Inventors: Akira Muramatsu, Kyoto-shi (JP); Ayaka Yamano, Kyoto-shi (JP); Nobuhiro Hanafusa, Kyoto-shi (JP); Masamitsu Shikata, Kyoto-shi (JP)

(73) Assignee: SHIMADZU CORPORATION, Kyoto-shi (JP)

(21) Appl. No.: 16/559,126

(22) Filed: Sep. 3, 2019

(30) Foreign Application Priority Data
Dec. 14, 2018 (JP) 2018-234460

(51) Int. Cl. B03C 1/01; B03C 1/28; B01L 3/00

(52) U.S. Cl. CPC B03C 1/01; H01F 7/02; B01L 3/508; B03C 1/288

(57) ABSTRACT

A container has a tubular form, and has gel-like medium layers and liquid layers alternately stacked in a longitudinal direction. Magnetic particles, having a target substance immobilized thereon and loaded inside the container, can be moved sequentially through the gel-like medium layers and the liquid layers by moving an external magnet. The container has an information holding part that holds identification information. The identification information is correlated to a control program product for moving the magnet.

### BACKGROUND OF THE INVENTION

### Field of the Invention

The present invention relates to a magnetic particle manipulating container having a gel-like medium layer and a liquid layer alternately stacked in a longitudinal direction, and being designed to move a magnetic particle loaded inside, with a target substance immobilized thereon, sequentially through the gel-like medium layer and the liquid layer, by moving an external magnet; and a magnetic particle manipulating apparatus.

### Description of the Related Art

In fields of medical inspection, food safety and hygiene management, and environmental preservation monitoring, it has been demanded to extract a target substance from a sample that contains a wide variety of impurities, and to subject the target substance to detection or reaction. For example in medical inspection, there are needs for detection, identification and quantification of nucleic acids, proteins, sugars, lipids, bacteria, viruses, radioactive substances and so forth, contained in plants, or isolated from blood, serum, cell, urine and feces of animals. For such inspection, it is occasionally necessary to isolate and purify the target substance, in order to eliminate any adverse influences from backgrounds due to the impurities.

Aimed at isolating and purifying the target substances in samples, there have been developed and practiced methods of using magnetic particles each including a magnetic body having a size of 0.5 μm to several tens micrometers or around, a surface of the magnetic body being functionalized with chemical affinity to the target substances or molecular recognition. In these methods, repeated are a step of immobilizing the target substance on the surface of magnetic particle, a step of isolating and collecting the magnetic particle from a liquid phase by magnetic manipulation, an optional step of allowing the thus collected magnetic particle to disperse in a liquid phase such as washing liquid, and a step of isolating and collecting the magnetic particle from the liquid phase. Thereafter, the magnetic particle is allowed to disperse in an eluent, so as to liberate in the eluent the target substance having been immobilized to the magnetic particle, and the target substance in the eluent is collected. Employment of the magnetic particle enables collection of the target substance using a magnet, and is advantageous in automated chemical extraction and purification.

The magnetic particle, allowed for selective immobilization of target substances, is commercially available as a part of isolation/purification kit. The kit contains a plurality of reagents enclosed in separate containers, from which the user sucks up and dispenses the reagents using a pipette or the like. Also devices for automatizing such pipetting or magnetic manipulation have been launched onto the market (WO 97/44671). Meanwhile rather than relying upon such pipetting, there has been proposed a method of using a tubular device having a tubular container such as capillary in which liquid layers composed of solubilization/fixation liquid, washing liquid or eluent, and gel-like medium layers are alternately stacked, the device being designed to isolate and purify the target substance by moving therein the magnetic particle in the longitudinal direction of the container (WO 2012/086243).

In the aforementioned configuration in which the magnetic particle moves in the tubular container, a magnet that is provided as a magnetic field applying unit outside the container is moved in the longitudinal direction of the container, to cause changes in magnetic field. In compliance with such changes in magnetic field, the magnetic particle moves in the longitudinal direction of the container, so as to sequentially move through the alternately stacked liquid layers and the gel-like medium layers.

The magnet is automatically moved in the longitudinal direction of the container, according to a control program product run by a control unit. The magnet is controlled so as to vary its movement at the individual positions corresponding to the liquid layers and the gel-like medium layers, rather than simply moving at a constant speed.

Since positions of the liquid layers and gel-like medium layers in the container may vary depending on the length of the container or liquid volume of the individual layers in the container, so that the control will vary depending on types of the container (and the contents). Required movement of the magnet also varies depending on whether the target substance is DNA or RNA, so that the control is given in different ways depending on whether the container is aimed at DNA or RNA.

For easy recognition of types of such container, for example, one possible idea is to place on the container a label bearing information on types of the container to be identified. In this case, the user checks the information given on the label, makes settings while being correlated to the information, and can run the control suited to the type of container.

It is, however, labor-consuming for the user to make setting on motion control of the magnet, with an anticipated risk of wrong setting. If the device is used under wrong setting, the container or the target substance would unfortunately be wasted.

In consideration of the aforementioned situation, it is therefore an object of the present invention to provide a magnetic particle manipulating container and a magnetic particle manipulating apparatus, capable of automatizing the setting regarding motion control of the magnet.

### SUMMARY OF THE INVENTION

(1) A magnetic particle manipulating container of the present invention has a gel-like medium layer and a liquid layer alternately stacked in a longitudinal direction, and is designed to move a magnetic particle loaded inside, with a target substance immobilized thereon, sequentially through the gel-like medium layer and the liquid layer by moving an external magnet. The magnetic particle manipulating container includes a container body and an information holding part. The container body is tubular, in which the gel-like medium layer and the liquid layer are alternately stacked in the longitudinal direction. The information holding part is provided to the container body and holds identification information. The identification information is correlated to a control program product for moving the magnet.

With such a configuration, the identification information correlated to the control program product for moving the magnet is held in the information holding part provided to the container body. Hence, by acquiring the identification information from the information holding part of the container body, it becomes possible to run the control program product correlated to that identification information. This enables automatizing of the setting regarding motion control of the magnet.

(2) The information holding part may hold, besides the identification information, parameter information used for running the control program product.

With such a configuration, not only the identification information, but also the parameter information used when running the control program product may be acquired from the information holding part of the container body, making it possible to perform motion control of the magnet. This makes setting regarding motion control of the magnet unnecessary.

(3) The information holding part may include a barcode or a two-dimensional code.

With such a configuration, the identification information may be held using a barcode or a two-dimensional code that can hold a relatively large volume of information. Since the information holding part can hold more detailed identification information, so that the control program product can be run in a manner well suited to a wide variety of types of the container body.

(4) A magnetic particle manipulating apparatus of the present invention includes a container holding part, an identification information acquisition unit, a storage unit, and a control unit. The container holding part holds the magnetic particle manipulating container. The identification information acquisition unit acquires the identification information from the information holding part of the magnetic particle manipulating container held by the container holding part. The storage unit stores a control program product while the control program product is correlated to the identification information. The control unit moves the magnet by reading out from the storage unit the control program product having been correlated to the identification information acquired by the identification information acquisition unit and by running the control program product.

With such a configuration, the control program product can be run automatically, while being correlated to the identification information acquired by the identification information acquisition unit from the information holding part of the magnetic particle manipulating container.

(5) The control unit may restrict moving operation of the magnet when the identification information acquisition unit fails in acquiring the identification information.

With such a configuration, moving operation of the magnet is restricted when the identification information acquisition unit fails in acquiring the identification information, in such a case where the magnetic particle manipulating container has not been set on the container holding part, thus preventing erroneous operation of the device.

According to the present invention, the control program product can be run while being correlated to the identification information whenever acquired from the information holding part of the container body, thus enabling automatizing of the setting regarding motion control of the magnet.

### BRIEF DESCRIPTION OF THE DRAWINGS

FIG. 1 is a front view illustrating an exemplary configuration of a magnetic particle manipulating device according to an embodiment of the present invention;

FIG. 2 is a cross-sectional view of the magnetic particle manipulating device illustrated in FIG. 1, taken along line A-A;

FIG. 3 is a perspective view illustrating an exemplary configuration of a magnetic particle manipulating apparatus according to an embodiment of the present invention;

FIG. 4 is a cross-sectional view of the magnetic particle manipulating apparatus illustrated in FIG. 3, taken along line B-B;

FIGS. 5A to 5C are schematic drawings illustrating modes of operating a magnetic particle;

FIG. 6 is a block diagram illustrating an exemplary electrical composition of the magnetic particle manipulating apparatus; and

FIG. 7 is a flowchart illustrating an exemplary control carried out by a control unit.

### DETAILED DESCRIPTION OF THE PREFERRED EMBODIMENTS

### 1. Configuration of Magnetic Particle Manipulating Device

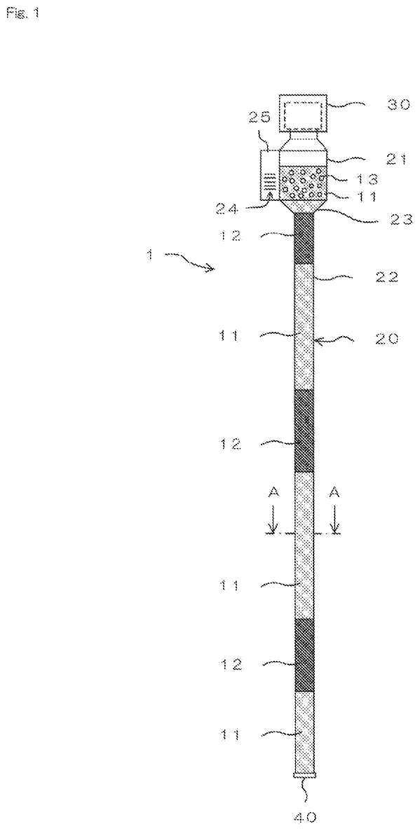

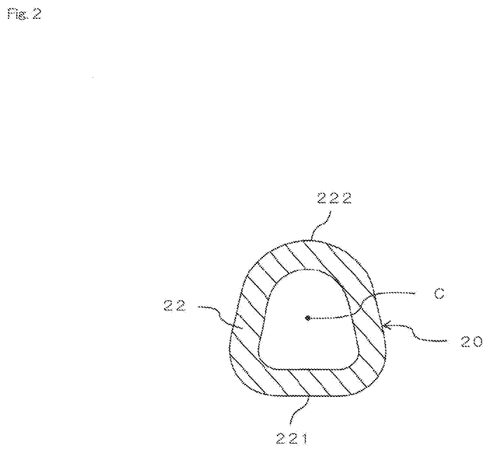

FIG. 1 is a front view illustrating an exemplary configuration of a magnetic particle manipulating device according to an embodiment of the present invention. FIG. 2 is a cross-sectional view of the magnetic particle manipulating device illustrated in FIG. 1, taken along line A-A. A magnetic particle manipulating device 1 (referred to as “device 1”, hereinafter) is designed to extract and purify a target substance from a liquid sample, and includes a tubular container (container body) 20 that extends straight.

In the container 20, there are formed a plurality of liquid layers 11 and a plurality of gel-like medium layers 12. More specifically, one liquid layer 11 is formed at the bottommost part of the container 20, and the gel-like medium layers 12 and the liquid layers 11 are alternately stacked upward in the longitudinal direction. While four liquid layers 11 and three gel-like medium layers 12 are alternately formed in the longitudinal direction in this example, the numbers of the liquid layers 11 and the gel-like medium layers 12 are freely selectable without being limited to the example.

The topmost liquid layer 11 in the container 20 is composed of a liquid sample that contains a target substance, in which a large number of magnetic particles 13 are loaded. The bottommost liquid layer 11 in the container 20 is composed of an eluent for eluting the target substance in the liquid sample. One or more (two, in this example) liquid layers 11 in the middle way of the container 20 are composed of a washing liquid for removing impurities contained in the liquid sample. These liquid layers 11 are isolated from each other by the gel-like medium layers 12. The target substance, contained in the liquid sample while being immobilized to the magnetic particles 13, is subjected to an operation (particle manipulation) for moving the particles from the topmost part down to the bottommost part of the container 20 making use of changes in the magnetic field, during which the target substance is washed through the washing liquid an then extracted into the bottommost extraction liquid.

The magnetic particle 13 is a particle capable of specifically immobilizing on the surface or inside thereof the target substance such as nucleic acid, antigen and so forth. By allowing the magnetic particles 13 to disperse in the topmost liquid layer 11 in the container 20, the target substance contained in the liquid layer 11 is selectively immobilized to the magnetic particles 13.

Methods for immobilizing the target substance to the magnetic particles 13 are not particularly limited, allowing usage of any known mechanism for immobilization, such as physical adsorption, chemical adsorption, and so forth. For example, the target substance may be immobilized on the surface or inside of the magnetic particles 13, with the aid of various intermolecular forces such as the van der Waals force, hydrogen bond, hydrophobic interaction, interionic interaction and n-n stacking.

The magnetic particle 13 preferably has a particle size of 1 mm or smaller, which is more preferably 0.1 μm to 500 μm, and even more preferably 3 to 5 μm. The magnetic particle 13 preferably has a spherical shape with a uniform particle size, but may have shape irregularity and some degrees of particle size distribution, so long as the particles are manipulable. The magnetic particle 13 may be composed of a single component, or of a plurality of components.

The magnetic particle 13 may be composed of a magnetic body only, but may preferably be composed of any magnetic body having on the surface a coating for specifically immobilizing the target substance. The magnetic body is exemplified by iron, cobalt and nickel, as well as compounds, oxides and alloys of these metals. More specifically, exemplified are magnetite (Fe₃O₄), hematite (Fe₂O₃ or —Fe₂O₃), maghemite (γ-Fe₂O₃), titanomagnetite (xFe₂TiO₄.(1−x)Fe₃O₄), ilmenohematite (xFeTiO₃.(1−x)Fe₂O₃), pyrrhotite (Fe₁₋ₓS (x=0 to 0.13) to Fe₇S₈ (x≈0.13)), greigite (Fe₃S₄), goethite (α-FeOOH), chromium oxide (CrO₂), permalloy, alnico magnet, stainless steel, samarium magnet, neodymium magnet, and barium magnet.

The target substance to be selectively immobilized to the magnetic particle 13 is exemplified by biologically derived substances such as nucleic acids, proteins, sugars, lipids, antibodies, receptors, antigens and ligand, as well as cells per se. The target substance, when being a biologically derived substance, may be immobilized on the surface or inside of the magnetic particle 13 by molecular recognition. For example, if the target substance is a nucleic acid, then as the magnetic particle 13, a magnetic particle having a silica coated surface is preferably employed. If the target substance is an antibody (for example, labeled antibody), receptor, antigen, ligand or the like, then the target substance may selectively be immobilized on the particle surface making use of amino group, carboxy group or epoxy group on the surface of the magnetic particle 13, as well as avidin, biotin, digoxigenin, protein A or protein G. As the magnetic particle 13 capable of selectively immobilizing specific target substances, also exemplified are Dynabeads (registered trademark) marketed by Thermo Fisher Scientific K.K., and magnetic beads contained in Magextractor (registered trademark) marketed in the form of kit from Toyobo Co., Ltd.

If the target substance is a nucleic acid, the washing liquid will suffice if it can liberate into the washing liquid any component (for example, protein, sugar and so forth) other than the nucleic acid contained in the liquid sample or a reagent used for extracting the nucleic acid, while keeping the nucleic acid immobilized onto the surface of the magnetic particles 13. The washing liquid is exemplified by dense aqueous solutions of salts such as sodium chloride, potassium chloride and ammonium sulfate; and aqueous solutions of alcohol such as ethanol and isopropanol.

As the eluent for eluting nucleic acid (nucleic acid eluent), employable is water or buffer containing a low concentration of salt. More specifically, employable are Tris buffer, phosphate buffer and distilled water, and is typically a 5 to 20 mM Tris buffer with pH adjusted to 7 to 9. By allowing the magnetic particles 13 with the immobilized nucleic acid to disperse in the eluent, the nucleic acid may be liberated and eluted into the nucleic acid eluent. The collected nucleic acid may be subjected to analysis or reaction, after being optionally condensed or dried.

The gel-like medium layer 12 is in a gel-like form or in a pasty form, before particle manipulation. The gel-like medium layer 12 is preferably insoluble or poorly soluble in the neighboring liquid layer 11, and is composed of a chemically inert substance. Now “insoluble or poorly soluble in liquid” means that solubility in the liquid at 25° C. is approximately 100 ppm or below. The chemically inert substance means a substance which does not chemically affect the liquid layers 11, the magnetic particles 13 or the substance immobilized on the magnetic particles 13, upon contact with the liquid layer 11 or during manipulation of the magnetic particles 13 (that is, operation for moving the magnetic particles 13 in the gel-like medium layers 12).

Materials and chemical compositions of the gel-like medium layer 12 are not particularly limited, allowing physical gel or chemical gel to be used. For example, as illustratively described in WO2012/086243, the physical gel may be formed by heating a water-insoluble or poorly water-soluble liquid substance, adding a gelling agent to the thus heated liquid substance, thoroughly dissolving the gelling agent, and then cooling the mixture equal to or lower than the sol-gel transition temperature.

Loading of the liquid layers 11 and the gel-like medium layers 12 into the container 20 may rely upon any appropriate method. In a case where the tubular container 20 is used as illustrated in this embodiment, one opening at one end (bottom end, for example) of the container 20 is preferably sealed prior to the loading, and the liquid layers 11 and the gel-like medium layers 12 are sequentially loaded from the other opening at the other end (top end, for example).

Volume of the liquid layers 11 and the gel-like medium layers 12 to be loaded into the container 20 may appropriately be determined, depending on volume of the magnetic particles 13 to be manipulated, or types of manipulation. In a case where a plurality of liquid layers 11 and gel-like medium layers 12 are provided in the container 20 as illustrated in this embodiment, the individual layers may have the same volume or different volumes. Also thickness of the individual layers may be determined appropriately. In consideration of manipulability, the thickness of the individual layers is preferably 2 mm to 20 mm or around for example.

The topmost part of the container 20 is formed into a bulged part 21 with an inner diameter and an outer diameter both larger than those of the other part. The bulged part 21 has an opened top which is sealable with a cap 30 detachably provided to the bulged part 21. The topmost liquid layer 11 in the container 20 may be formed by injecting, with the cap 30 detached, the liquid sample into the bulged part 21.

Below the bulged part 21, the container 20 has a straight part 22 whose cross-sectional shape taken in the direction perpendicular to the longitudinal direction is kept constant as illustrated in FIG. 2. The bulged part 21 and the straight part 22 are connected with a tapered part 23 that is narrowed from the bulged part 21 towards the straight part 22. At the lower end of the straight part 22 (bottom of the container 20), formed is an opening which is sealed with a film member 40. The target substance, extracted into an eluent serving as the bottommost liquid layer 11 in the container 20, may be sucked up into a pipette by piercing the film member 40 with the pipette so as to be inserted into the eluent. For example, the film member 40 is, but not limitedly, formed of aluminum and the like.

Materials for the container 20 are not particularly limited, so long as the magnetic particles 13 may be moved in the container 20, and the liquid layers 11 and the gel-like medium layer 12 can be retained. For the purpose of moving the magnetic particles 13 in the container 20 in response to an operation for changing the magnetic field (magnetic manipulation) from outside of the container 20, preferable are magnetically permeable materials such as plastics, which are exemplified by resin materials including polyolefins such as polypropylene and polyethylene; fluorine-containing resins such as polytetrafluoroethylene; polyvinyl chloride; polystyrene; polycarbonate; and cyclic polyolefins. Materials for the container 20, besides those enumerated above, also include ceramic, glass, silicone, and non-magnetic metals. For improved water repellency of the inner wall, the container 20 may even have an inner wall coated with a fluorine-containing resin or silicone.

The container 20 has a cross-sectional shape (viewed perpendicularly to the longitudinal direction) in the straight part 22 below the bulged part 21, which is asymmetrical about a center C as illustrated in FIG. 2. More specifically, the straight part 22 has a flat face 221 on the front outer circumference, and has a convexly curved face 222 on the rear outer circumference which is on the opposite side of the center C. Note, however, that the shape of the container 20 is not limited to the aforementioned one, allowing instead that the straight part 22 has a cross-sectional shape symmetrical about the center C (circular, for example). In the part of the container 20 below the bulged part 21, the straight part 22 may have a stepped shape whose cross section is variable, rather than the constant cross-sectional shape. In this case, large diameter parts and small diameter parts may alternately be arranged for example.

The container 20 has an information holding part 24 that holds identification information. The information holding part 24 includes a barcode for example. In this example, the information holding part 24 is placed on a protruded tab 25 that protrudes out as a part of the container 20. More specifically, the protruded tab 25 is formed so as to protrude in a radial direction from the bulged part 21 of the container 20, and the information holding part 24 is placed on one face of the protruded tab 25.

Note, however, that the protruded tab 25 on which the information holding part 24 is placed does not always necessarily protrude from the bulged part 21 of the container 20, and may instead protrude from a part other than the bulged part 21 of the container 20. Still alternatively, the information holding part 24 may be placed on other parts such as the bulged part 21 or the straight part 22, rather than on the protruded tab 25.

The information holding part 24 is not limited to those including the barcode, but may be those including other codes such as two-dimensional code. The information holding part 24 may still alternatively be any of those capable of holding the identification information, such as an IC tag capable of transmitting the identification information. The information holding part 24 may alternatively be given by a mechanical structure such as projections on the container 20, if position and quantity of the projections are designed to be read in an optical manner.

### 2. Configuration of Magnetic Particle Manipulating Apparatus

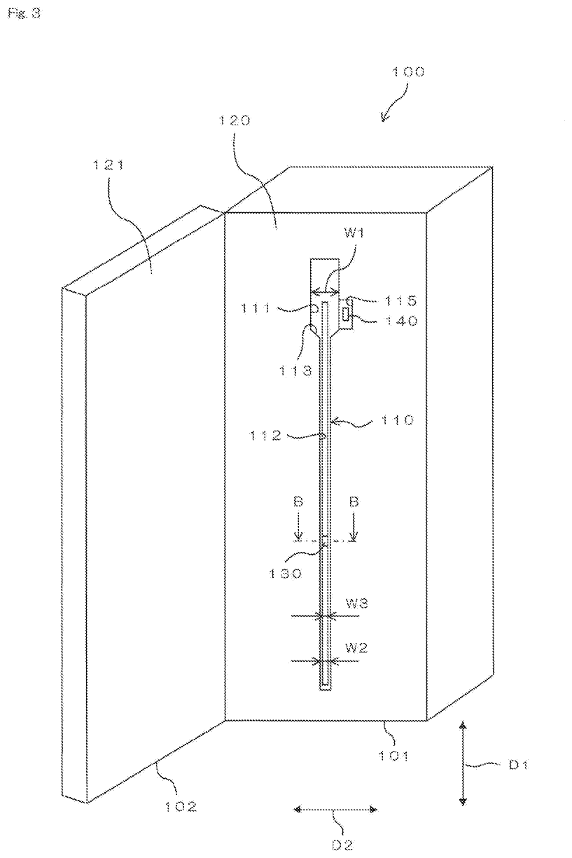

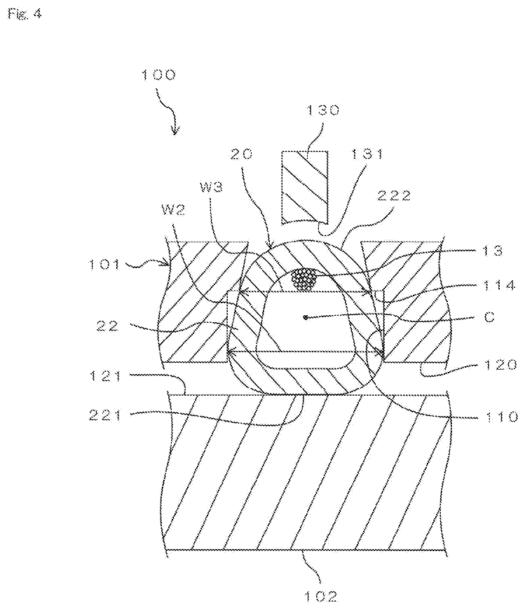

FIG. 3 is a perspective view illustrating an exemplary configuration of a magnetic particle manipulating apparatus according to an embodiment of the present invention. FIG. 4 is a cross-sectional view of the magnetic particle manipulating apparatus illustrated in FIG. 3, taken along line B-B. A magnetic particle manipulating apparatus 100 (simply referred to as “apparatus 100”, hereinafter) is used with the device 1 illustrated in FIG. 1 and FIG. 2 held thereon, aimed at particle-manipulating a target substance contained in the liquid sample in the container 20 of the device 1.

The apparatus 100 has a main body 101 having a container holding part 110 formed so as to hold the device 1, and a container pressurizing part 102 that pressurizes and fixes the container 20 of the device 1 held by the container holding part 110. In this example, the container pressurizing part 102 includes a door pivotably attached to the main body 101 through hinges (not illustrated). Note, however, that the container pressurizing part 102 is not limited to have such a configuration pivotable around the main body 101 so long as it can fix the device 1 held by the container holding part 110, allowing instead a configuration which is slidable relative to the main body 101, or a configuration which is detachable from the main body 101 to be used.

The container holding part 110 includes a recess formed in a front face 120 of the main body 101. The container holding part 110 has a first housing part 111 that houses the bulged part 21 of the container 20 of the device 1, and a second housing part 112 that houses the straight part 22, with both parts extended in a row in a vertical direction D1. The container holding part 110 has a width corresponding to the device 1, the width being defined in a lateral direction D2 which is parallel to the front face 120 of the main body 101, and perpendicular to direction (vertical direction D1) the straight part 22 extends.

More specifically, a width W1 in the lateral direction D2 of the first housing part 111 is slightly larger than the width of the bulged part 21 of the container 20. Meanwhile, a width W2 in the lateral direction D2 of the second housing part 112 is slightly larger than the width of the straight part 22 of the container 20, and smaller than the width of the bulged part 21. The first housing part 111 and the second housing part 112 are connected with a drawn part 113 that inclines at an angle corresponding to the tapered part 23 of the container 20. Hence, the container 20 when housed in the container holding part 110 is held in such a way that the tapered part 23 of the container 20 is hooked on, and suspended from the drawn part 113 of the container holding part 110.

In the front face 120 of the main body 101, there is formed a third housing part 115 that houses the protruded tab 25, at a position corresponding to the protruded tab 25 of the container 20. The third housing part 115 has a reader 140 that reads the identification information from the information holding part 24 provided to the protruded tab 25. With the container 20 held in the container holding part 110, the protruded tab 25 is housed in the third housing part 115, and the information holding part 24 provided to the protruded tab 25 is opposed to the reader 140.

As illustrated in FIG. 4, the container 20 is housed in the container holding part 110, such that the flat face 221 aligns in the lateral direction D2, and the convexly curved face 222 is positioned on the rear side of the flat face 221. The second housing part 112 of the container holding part 110 has, on the inner face thereof, steps 114 that protrude from both sides inwardly in the lateral direction D2. A width W3 in the lateral direction D2 of the first housing part 111 at the steps 114 is smaller than the width W2 on the front face 120 side, and also smaller than the width in the lateral direction D2 of the straight part 22 of the container 20.

Hence, the straight part 22 of the container 20 housed from the front face 120 side into the container holding part 110 is held, with the convexly curved face 222 side brought into contact with the steps 114. The flat face 221 of the container 20 in this state stays protruded from the container holding part 110, ahead of the front face 120 of the main body 101. Now, upon closure of the door that configures the container pressurizing part 102, a contact face 121 that opposes with the front face 120 of the main body 101 is brought into contact with the flat face 221 of the container 20 as illustrated in FIG. 4, and can pressurize the container 20 towards the rear side. In this way, the straight part 22 of the container 20 is held between the contact face 121 and the steps 114, making it possible to tightly fix the straight part 22.

The container holding part 110 has an opened back, and a magnet 130 is arranged opposedly to the container holding part 110. The magnet 130 is placed in proximity to the outside (rear side) of the container 20 held in the container holding part 110. The magnet 130 is composed of a permanent magnet, and is held slidably in the vertical direction D1.

The magnet 130 magnetically attracts the magnetic particles 13 in the container 20. Hence as illustrated in FIG. 4, the magnetic particles 13 are gathered to the side of the convexly curved face 222. By moving the magnet 130 in the vertical direction D1 with the magnetic particles 13 thus attracted to the magnet 130 side, the magnetic particles 13 in the container 20 may be moved in the vertical direction D1.

As described above, the magnet 130 configures a magnetic field applying unit that moves the magnetic particles 13 in the container 20 by changing the magnetic field. The magnet 130 may be slid by a driving unit, or may be slid manually. In the example illustrated in FIG. 4, the magnet 130 has an opposing face 131 opposed to the container 20, which has a concavely curved face. The opposing face 131 is a concavely curved face having a radius of curvature corresponding to the convexly curved face 222 of the container 20. Note, however, that the opposing face 131 is not limited to any of those having concavely curved faces, but also may be any of those having a flat face for example.

Shape, size and material of the magnet 130 are not particularly limited, so long as the magnetic particle 13 is manipulable. As a magnetic source included in the magnetic field applying unit, employable is not only permanent magnet but also electromagnet. The magnetic field applying unit may have a plurality of magnetic sources. The magnetic field applying unit will suffice if it can change the magnetic field as a result of movement relative to the container 20, being not limited to have a configuration that relies upon movement of the magnetic field applying unit as in this embodiment, but also may have a configuration that relies upon movement of the container 20.

### 3. Manipulation of Magnetic Particles

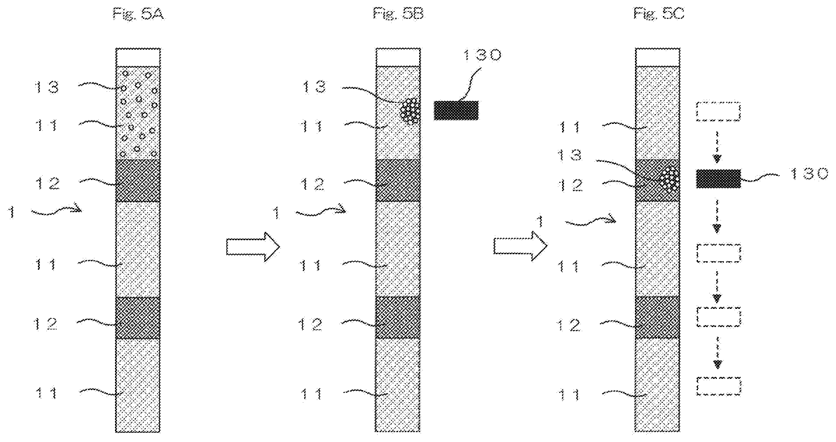

FIGS. 5A to 5C are schematic drawings illustrating modes of operating the magnetic particles 13. FIGS. 5A to 5C simplify the shape of the device 1 for simplicity of explanation. As seen in FIG. 5A, the topmost liquid layer 11 in the container 20 contains a large number of magnetic particles 13. By allowing the magnetic particles 13 to disperse in the liquid layer 11 in this way, the target substance contained in the liquid layer 11 is selectively immobilized on the magnetic particles 13.

Then upon approach of the magnet 130 as a magnetic source to the outer circumference of the container 20 as illustrated in FIG. 5B, the magnetic particles 13 with the immobilized target substance are gathered into the magnet 130 side in the container 20 (convexly curved face 222 side) while being assisted by the magnetic field. Then as the magnet 130 moves along the outer circumference of the container 20 in the longitudinal direction (vertical direction) of the container 20 as illustrated in FIG. 5C, also the magnetic particles 13 move in the longitudinal direction of the container 20, and sequentially travel through the liquid layers 11 and the gel-like medium layers 12 that are alternately stacked.

Most of the liquid physically adhered in the form of droplets around the magnetic particles 13 are released from the surface of the magnetic particles 13 before the magnetic particles 13 enter the gel-like medium layers 12. While the gel-like medium layers 12 are dug upon entrance and movement therethrough of the magnetic particles 13, pits formed in the gel-like medium layers 12 are immediately buried by self-restoring action of the gel attributable to its resiliency. Hence, the liquid will hardly enter the gel-like medium layers 12 via through-holes that would otherwise be formed by the magnetic particles 13.

The magnet 130 reciprocates at positions opposite to each liquid layer 11 in the longitudinal direction of the container 20, with a predetermined movement stroke and at a predetermined movement speed, so as to allow the magnetic particles 13 to disperse in each liquid layer 11. By allowing the magnetic particles 13 to disperse in each liquid layer 11 and to contact with the liquid in each liquid layer 11, enabled are an operation for immobilizing the target substance onto the magnetic particles 13, an operation for washing for removing impurities adhered on the surface of the magnetic particles 13, an operation for reaction of the target substance immobilized on the magnetic particles 13, an operation for eluting the target substance immobilized on the magnetic particles 13 into the liquid, and so forth.

### 4. Control of Magnetic Particle Manipulating Apparatus

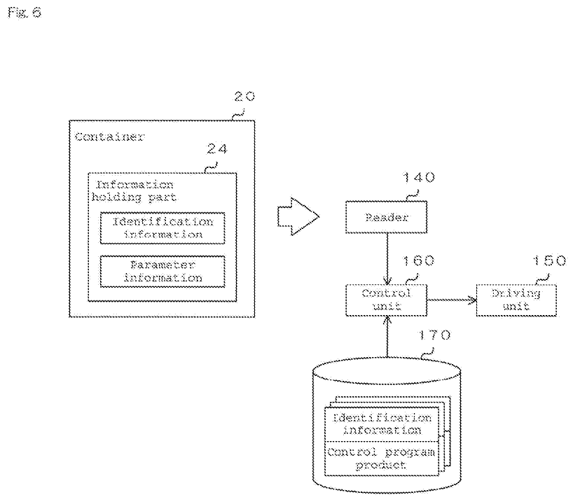

FIG. 6 is a block diagram illustrating an exemplary electrical composition of the magnetic particle manipulating apparatus. The magnetic particle manipulating apparatus (apparatus 100) has a driving unit 150, a control unit 160 and a storage unit 170, besides the aforementioned reader 140.

The driving unit 150 is a mechanism that moves the magnet 130 in the vertical direction D1 along the container 20, and has for example a motor, gears and so forth. The driving unit 150 is, however, not limited to have a configuration electrically driving the magnet 130, but also may have a configuration moving the magnet 130 with a hydraulic or other means.

The control unit 160 has a central processing unit (CPU) for example, to control operations of the apparatus 100. The driving unit 150 moves the magnet 130 according to a predetermined movement pattern, movement stroke and movement speed, while being controlled by the control unit 160 whose CPU runs a control program product.

The storage unit 170 includes for example a random access memory (RAM), hard disk or the like. The storage unit 170 stores the control program product that is run by the CPU of the control unit 160. In this embodiment, the control program product for moving the magnet 130 is stored in the storage unit 170, while being correlated to the identification information that is held by the information holding part 24 provided to the container 20.

The reader 140 configures an identification information acquisition unit that acquires the identification information by reading the identification information held in the information holding part 24. In this embodiment, the identification information held by the barcode as the information holding part 24 is read by the reader 140 including a barcode reader. The reader 140 is preferably capable of reading the identification information using an optical or electromagnetic means.

The control unit 160 reads, out from the storage unit 170, the control program product correlated to the identification information acquired by the reader 140. The control unit 160 then runs the thus read control program product, to move the magnet 130 according to the movement pattern correlated to the control program product. For example, the control program product is preliminarily stored in the storage unit 170 for each identification information (for each type of the container 20), as a program product for moving the magnet 130 according to the movement pattern corresponding to types of the container 20 (length of the container 20 and positions of the liquid layers 11 in the container 20).

In this embodiment, not only the identification information, but also parameter information is held in the information holding part 24. The parameter information is used when the CPU of the control unit 160 runs the control program product, and contains movement stroke and movement speed of the magnet 130 when moved for example.

That is, in this embodiment, when the reader 140 reads the identification information from the information holding part 24, it also reads the parameter information. When the control program product, correlated to the thus read identification information, is read out from the storage unit 170 and run, the control unit 160 uses the identification information as well as the thus read parameter information to control movement of the magnet 130. Note that setting of the parameter information read by the reader 140 may be changed by the user through operation made on the apparatus 100. As described above, the parameter information may be changeable information regarding movement of the magnet 130.

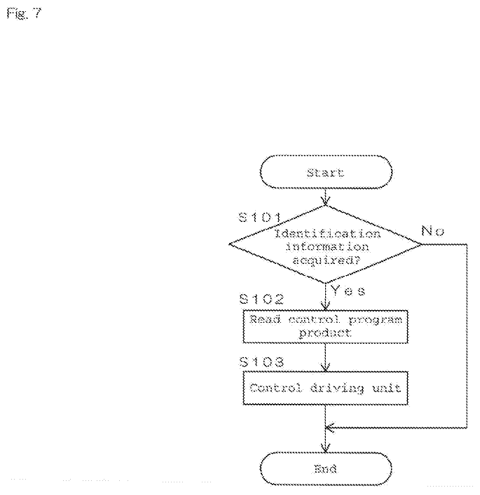

FIG. 7 is a flowchart illustrating an exemplary control by the control unit 160. The control illustrated in FIG. 7 starts when the container pressurizing part 102 as a door is closed on the main body 101 of the apparatus 100 for example. Hence, the apparatus 100 may have an opening/closing sensor that detects open/close state of the container pressurizing part 102.

Upon closure of the container pressurizing part 102 with the container 20 correctly set on the container holding part 110, the reader 140 acquires the identification information from the information holding part 24 of the container 20 (Yes in step S101). In this embodiment, also the parameter information is acquired from the information holding part 24 together with the identification information at this timing.

The control unit 160 reads the control program product correlated to the thus acquired identification information from the storage unit 170 (step S102), and runs the control program product to control operation of the driving unit 150, to thereby move the magnet 130 (step S103). In this step, movement of the magnet 130 is controlled by using the parameter information read out together with the identification information.

On the other hand, in a case where the container 20 is not set on the container holding part 110, the reader 140 cannot acquire the identification information (No in step S101). In this case, control of the driving unit 150 by the control unit 160 (step S103) is not available, thus restricting movement of the magnet 130.

### 5. Operations and Effects

(1) In this embodiment, the identification information correlated to the control program product for moving the magnet 130 is held in the information holding part 24 provided to the container 20. Hence, by acquiring the identification information from the information holding part 24 of the container 20, the control program product correlated to the identification information can be run (steps S102, S103 in FIG. 7). This automatizes setting regarding motion control of the magnet 130.

(2) In this embodiment, not only the identification information, but also the parameter information used for running the control program product is acquired from the information holding part 24 of the container 20, and the parameter information can be used for motion control of the magnet 130. This eliminates setting regarding motion control of the magnet 130.

(3) The information holding part 24, when including a barcode or a two-dimensional code, can hold a relatively large volume of information. Hence, more detailed identification information may be held by the information holding part 24, making it possible to run the control program product suited to a wide variety of the containers 20. Moreover, with the configuration of this embodiment in which not only the identification information but also the parameter information is held in the information holding part 24, more detailed parameter information may be held in the information holding part 24.

(4) In this embodiment, if the reader 140 fails in acquiring the identification information (No in step S101 in FIG. 7), such as a case of absence of the container 20 on the container holding part 110, moving operation of the magnet 130 is restricted, making it possible to prevent erroneous operation of the apparatus 100.

### 6. Modified Examples

The aforementioned embodiment has described a configuration in which the parameter information is held together with the identification information in the information holding part 24. The embodiment is, however, not limited to the configuration, allowing instead that the parameter information may be stored, not in the information holding part 24, but in the storage unit 170 while being correlated to the identification information. In this case, a possible design is such that the user can operate an operating unit (not illustrated) provided to the apparatus 100, so as to store the parameter information in the storage unit 170, or to change the parameter information stored in the storage unit 170.

The container 20 is not limited to have the shape illustrated in FIGS. 1 and 2, but may have any other configuration, so long as the liquid layers 11 and gel-like medium layers 12 may be alternately stacked therein in the longitudinal direction, and the magnetic particles 13 may be loaded therein.

What is claimed is:

1. A magnetic particle manipulating container having a gel-like medium layer and a liquid layer alternately stacked in a longitudinal direction, and being designed to move a magnetic particle loaded inside, with a target substance immobilized thereon, sequentially through the gel-like medium layer and the liquid layer by moving an external magnet, the magnetic particle manipulating container comprising:
a tubular container body in which the gel-like medium layer and the liquid layer are alternately stacked in the longitudinal direction; and
an information holding part that is provided to the container body and holds identification information, and
the identification information being correlated to a control program product for moving the magnet.

2. The magnetic particle manipulating container according to claim 1, wherein the information holding part holds, besides the identification information, parameter information used for running the control program product.

3. The magnetic particle manipulating container according to claim 1, wherein the information holding part comprises a barcode or a two-dimensional code.

4. A magnetic particle manipulating apparatus comprising:
a container holding part that holds the magnetic particle manipulating container according to claim 1;
an identification information acquisition unit that acquires the identification information from the information holding part of the magnetic particle manipulating container held by the container holding part;
a storage unit that stores a control program product while the control program product is correlated to the identification information; and
a control unit that moves the magnet by reading out from the storage unit the control program product having been correlated to the identification information acquired by the identification information acquisition unit and by running the control program product.

5. The magnetic particle manipulating apparatus according to claim 4, wherein the control unit restricts moving operation of the magnet when the identification information acquisition unit fails in acquiring the identification information.
